(19) United States
(12) Patent Application Publication
(10) Pub. No.: US 2006/0290254 A1
(43) Pub. Date: Dec. 28, 2006

(54) Spacer for field emission display device

(75) Inventors: Chi-Tsung Lo, Taipei City (TW); Tzung-Han Yang, Taipei City (TW); Jeng-Maw Chiou, Hsinchu (TW); Shy-Wen Lai, Hsinchu (TW); Cheng-Feng Lin, Hsinchu (TW); Chao-Hsun Lin, Hsinchu (TW)

Correspondence Address: BACON & THOMAS, PLLC, 625 SLATERS LANE, FOURTH FLOOR, ALEXANDRIA, VA, 22314, US

(73) Assignees: Tatung Company, Taipei City (TW); Industrial Technology Research Institute, Hsinchu (TW)

(21) Appl. No.: 11/455,838

(22) Filed: Jun. 20, 2006

(30) Foreign Application Priority Data
Jun. 24, 2005 (TW) 094121127

(51) Int. Cl. H01J 19/42; H01J 1/88; H01K 1/18

(52) U.S. Cl. 313/292

(57) ABSTRACT

The present invention provides a spacer placed between a top substrate and a bottom substrate for a field emission display device. The spacer comprises at least two insulating layers for electrical insulation; and at least one metal layer sandwiched between the insulating layers, wherein the metal layer has plural apertures for electrons passing therethrough and disturbing pathway of electrons as the electrons impact the apertures.

### BACKGROUND OF THE INVENTION

1. Field of the Invention

The present invention relates to a spacer and, more particularly, to a spacer for a field emission display device.

2. Description of Related Art

Many contemporary apparatuses, such as a computer, a television, a mobile phone, a personal digital assistant, or a vehicle information system, show signals through controlling a display device. Flat panel display devices, such as a liquid crystal display device, an organic light emitting display device, and a field emission display devices are the preferred display devices due to their low weight, small volume, and little effect to people's health. Among these flat panel display devices, the field emission display device (FED) has the advantages of good picture quality, high yield, short response time, easy-coordinating display characteristics, the brightness of over 100 ftL, low weight, minimal thickness, large color-temperature range, good operation efficiency, and wide viewing angle. Compared with the field emission display device, the viewing angle, the range of operation temperature, and the response time of the conventional liquid crystal display device are small. Besides, the field emission display device performs with high brightness even under sunlight because it is provided with a phosphor layer and it emits light without need for an additional back light module. Therefore, the field emission display device is considered to be the desired display device as it has the ability to compete with or replace the liquid crystal display device.

Under a vacuum circumstance lower than 10⁻⁶ torr, the field emission display device can generate electrons from the emitters on the cathode electrode while supplying an electric field. The electrons emitted from the emitters are subsequently attracted by the positive voltage applied to the anode electrode to thereby impact the phosphor powder and illuminate at the same time. It is known that the electric field supplied to the cathode electrode affects a quantity of the electrons emitted from the emitters. In other words, the larger the electric field supply to the cathode electrode, the more electrons are emitted from the emitters. However, the gate electrode disposed around the emitters has a shape of a ring. As a result, the electric field is not uniform because the electric field is formed in the peripheries of the emitters by the difference in voltage between the gate electrode and cathode electrode. For this reason, the dispersion of the electrons emitted from the emitters is presented with a ring shape, which results in disproportionate image brightness and decreases the picture quality of the field emission display device.

In addition, plural spacers are mounted in non-pixel regions and between the top substrate and the bottom substrate of the field emission display device such that a predetermined space is maintained between the top substrate and the bottom substrate. However, spacers of a conventional field emission display device are manufactured with a high aspect ratio to reduce the non-pixel regions occupied by the spacers in the whole display image. Hence, the spacer is easily skewed, and the manufacturing process of the spacer is difficult. Another conventional spacer is a comb-like structure having plural elongated filaments joined to at least one support member. The elongated filaments are positioned between the top substrate and the bottom substrate of the field emission display device so as to define a space between the top substrate and the bottom substrate. The manufacturing process of this spacer is easer than that of the spacer with high aspect ratio. However, the problem of the uneven dispersion of the electrons emitted from the emitters is still not eliminated.

Therefore, it is desirable to provide an improved spacer for a field emission display device to mitigate and/or obviate the aforementioned problems.

### SUMMARY OF THE INVENTION

The present invention provides a spacer placed between a top substrate and a bottom substrate for a field emission display device. The spacer comprises at least two insulating layers for electrical insulation; and at least one metal layer sandwiched between the insulating layers, wherein the metal layer has plural apertures for electrons passing therethrough and disturbing pathway of electrons as the electrons impact the apertures.

In other words, the spacer of the present invention is a stack of at least one metal layer and plural insulating layers. Therefore, the spacer can be manufactured without need for high aspect ratio, whereby the process of the spacer is simple, and the structure of the spacer is stable. Moreover, by changing the aperture shape of spacer, the spacer can disturb the pathway of the electrons emitted from the emitters while traveling to the top substrate. Thereby, the dispersion of the electrons landing on the phosphor layer is uniform. Besides, the sizes and positions of the apertures of the metal layers can be arranged to prevent the electrons impacting the cathode electrode and the contaminant from the anode electrode and the phosphor layer accumulating on the emitters or gate electrode. Furthermore, the metal layer of the spacer can act as a shield to isolate the cathode electrode and the high electric field applied to the anode electrode so that the circuit can be operated easily.

The type of the metal layer used in the spacer of the present invention is not limited. Preferably, the metal layer is a sheet metal having plural apertures or a mesh grid. The quantity of the metal layers sandwiched between two insulating layers is not limited. Preferably, every two insulating layers sandwich one to three conductive electrode layers. The shape of the inner wall of the aperture is not limited. Preferably, the inner wall of the aperture is selected from the group consisting of a concave inclined plane, a flat inclined plane, a vertical plane, a protruding inclined plane, and a combination thereof. More preferably, the inner wall of the aperture is a combination of an upper concave wall and a lower concave wall, and the diameters of the upper concave wall and the lower concave wall are different.

In addition, the metal layer's aperture sizes and positions in the present invention are not limited. Preferably, the apertures of different metal layer are arranged in different sizes and positions to avoid contaminant of the anode cathode and phosphor layer accumulating on the emitters or the cathode electrode as such accumulation decreases the lifetime of the field emission display device. More preferably, the diameters of the apertures of the metal layers become larger from the first substrate toward the second substrate, and the centers of the apertures of the conductive electrode layers are not on the same line perpendicular to the first substrate, or the combination thereof.

The type of the insulating layer used in the spacer of the present invention is not limited. Preferably, the insulating layer is composed of plural columns or a continuous structure with plural tubes.

Other objects, advantages, and novel features of the invention will become more apparent from the following detailed description when taken in conjunction with the accompanying drawings.

### BRIEF DESCRIPTION OF THE DRAWINGS

FIG. 1 is a sectional schematic view of a field emission display device according to a preferred embodiment of the present invention;

FIG. 2 is a perspective sectional drawing of the metal layer shown in FIG. 1;

FIG. 3 is a sectional drawing of another metal layer according to the embodiment of the present invention;

FIG. 4 is a sectional drawing of a further metal layer according to the embodiment of the present invention;

FIG. 5 is a sectional drawing of another metal layer according to the embodiment of the present invention;

FIG. 6 is a sectional schematic view of a field emission display device according to another preferred embodiment of the present invention;

FIG. 7 is a schematic sectional drawing of a spacer having multiple metal layers according to the embodiment of the present invention; and

FIG. 8 is a schematic sectional drawing of another spacer having multiple metal layers according to the embodiment of the present invention.

### DETAILED DESCRIPTION OF THE PREFERRED EMBODIMENT

### Embodiment 1

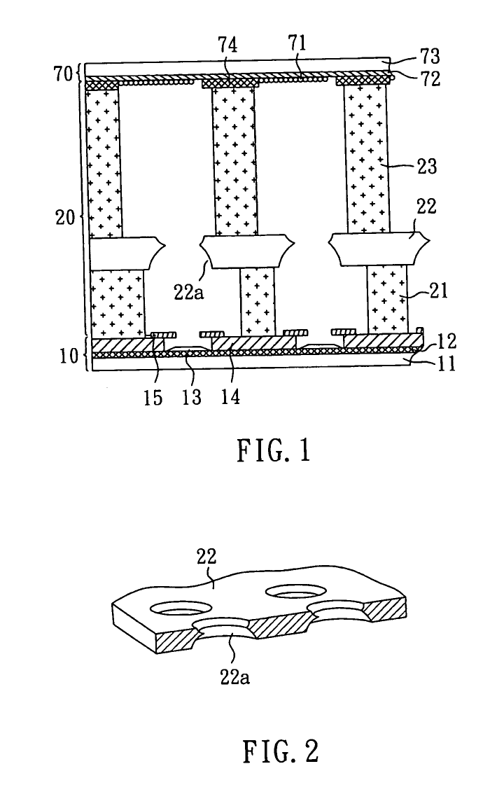

With reference to FIG. 1, there is shown a sectional schematic view of a field emission display device according to embodiment 1 of the present invention. In this embodiment, the field emission display device comprises a bottom substrate 10, a top substrate 70, and spacers 20 mounted therebetween.

As shown in FIG. 1, the bottom substrate comprises a first substrate 11, a cathode electrode 12, plural emitters 13, an insulating layer 14, and plural gate electrodes 15. The cathode electrode 12 is disposed on the first substrate 11, and the emitters 13 are disposed on the cathode electrode 12 at appropriate positions. Besides, the emitters 13 are made of electron-emitting material, such as carbon nanotubes for providing the primary emission electrons in the luminescence mechanism. Therefore, by controlling the voltage applied between the cathode electrode 12 and the gate electrode 15, emitters 13 can emit electrons at a predetermined time.

The top substrate 70 comprises a phosphor layer 71, a black matrix layer 74, an anode electrode 72, and a second substrate 73. The anode electrode 72 is made of indium tin oxide (ITO) or other transparent conductive materials. The phosphor layer 71 and the black matrix layer 74 are disposed on the lower surface of the anode electrode 72, and the phosphor layer 71 is made of phosphor powders or other phosphor materials. The second substrate 73 is disposed on upper surface of the anode electrode 72, and the material of second substrate 73 is glass or other transparent materials.

In the FED structure as in the above, voltages are applied to the gate electrode 15, the cathode electrode 12, and the anode electrode 72 to drive the FED. The electrons are emitted from the emitters 13 and move up the anode electrode 73 by application of voltage potential difference between the cathode electrode 12 and the anode electrode 72, and impact the phosphor layer 71 to provide light for viewing.

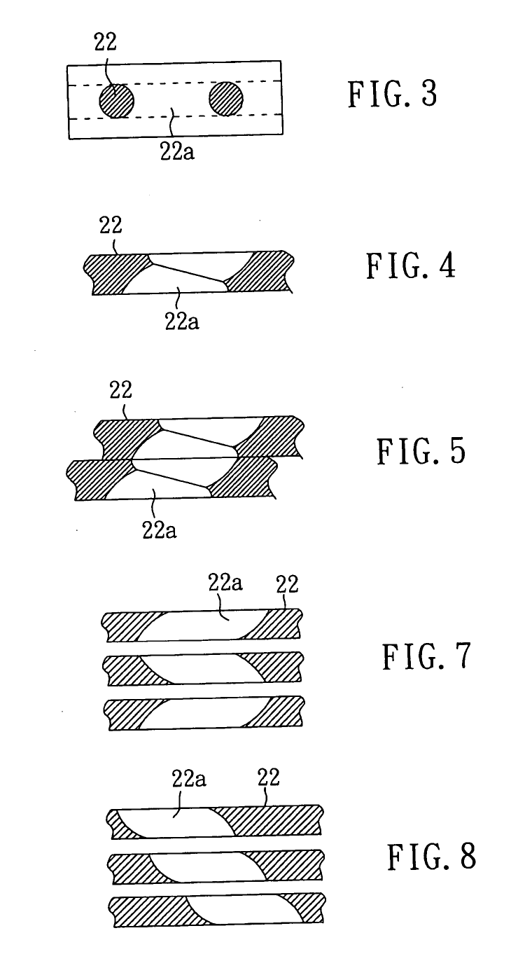

Referring to FIG. 1 and FIG. 2, the spacer 20 is placed between the bottom substrate 10 and the top substrate 70 to define a space therebetween. The spacer 20 comprises a second insulating layer 21, a metal layer 22, and a third insulating layer 23. The second insulating layer 21 is disposed upon the first insulating layer 14 and is composed of plural insulating pillars or a continuous tubular structure for electrical insulation. The metal layer 22 can be a sheet metal having plural apertures 22a (shown in FIG. 2) or a mesh grid (shown in FIG. 3).

The first metal layer can act as a shielding to the top substrate 70 and the bottom substrate 10. Therefore, the cathode electrode 12 is not affected by the high positive voltage applied to the anode electrode 72 such that the circuit of the field emission display device can be controlled effectively.

In this embodiment, the inner wall of the aperture 22a comprises an upper concave wall and a lower concave wall, and the diameter of the lower concave wall is larger than that of the upper concave wall as shown in FIG. 2. Otherwise, the wall inside the aperture 22a can be of different shapes. For example, the upper concave wall and the lower concave wall of the aperture 22a can be both asymmetrical concave walls as shown in FIG. 4. Also, two apertures 22a with symmetrical or asymmetrical concave walls can be combined to form an aperture having a complex shape as shown in FIG. 5.

In this embodiment, the electric fields are formed in the peripheries of emitters 13 by the difference in voltage between gate electrode 15 and cathode electrode 12 such that electrons are emitted from the emitters 13. Then, these electrons are attracted by the positive voltage applied to the first metal layer 22 and impact the inner wall of the aperture of the metal layer while traveling toward the top substrate 70.

Because of the impact, the pathways of these electrons are disturbed while traveling toward the top substrate 70, and thereby the dispersion of these electrons is disturbed to become uniform even though the dispersion of these electrons is not uniform at the beginning. In other words, the spacers 20 can make uniform the dispersion of the electrons emitted from the emitters so as to improve the image quality of the field emission display device. Moreover, the concave inner wall of the aperture 22a of the first metal layer in this embodiment can avoid contaminant from anode cathode 72 and phosphor layer 71 accumulating on the emitters 13 or the gate electrode 15 as such accumulation decreases the lifetime of the field emission display device.

In addition, the spacer 20 is a stack of the second insulating layer 21, the metal layer 22, and the third insulating layer 23. Therefore, the problems of high aspect ratio, difficult processing, and easy skewing can be eliminated. In other words, the spacer 20 in this embodiment can be manufactured without need for high aspect ratio, the process of the spacer is simple, and the structure is stable.

### Embodiment 2

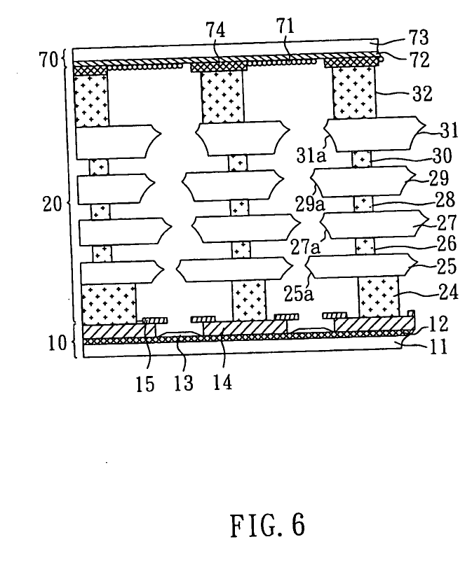

With reference to FIG. 6, there is shown a sectional schematic view of another embodiment of the present invention. The structure of the field emission display device in this embodiment is similar to that of the FED in the embodiment 1, except for the spacers 20.

As shown in FIG. 6, the spacer 20 comprises a fourth insulating layer 24, a second metal layer 25, a fifth insulating layer 26, a third metal layer 27, a sixth insulating layer 28, a fourth metal layer 29, a seventh insulating layer 30, a fifth metal layer 31, and an eighth insulating layer 32.

In addition, the sizes and positions of the apertures 25a, 27a, 29a and 31a can be arranged (shown in FIG. 6, FIG. 7, and FIG. 8). As shown in FIG. 6, the aperture 3 la of the fifth metal layer is largest in size with the aperture 29a of the fourth metal layer 29 being second largest, the aperture 27a of the third metal layer 27 the third largest, and the aperture 25a of the second metal layer 25 the smallest. Thus, the cations backflow can be prevented. Moreover, the centers of the apertures 25a, 27a, 29a, 31a corresponding to an emitter 13 are not on the same line perpendicular to the bottom substrate 10, and thereby the accumulation of the contaminant from anode electrode 72 or phosphor layer 71 on the emitters 13 or the gate electrodes 15 can be prevented. Accordingly, the lifetime of the FED can be increased.

In this embodiment, the electric fields are formed by the difference in voltage between gate electrode 15 and cathode electrode 12 such that electrons are emitted from the emitters 13. Then, these electrons are attracted by the positive voltage applied to the second metal layer 25 and impact the inner wall of the aperture 25a. Next, these electrons are attracted by the positive voltage applied to the third metal layer 27 to thereby impact the inner wall of the aperture 27a. Subsequently, these electrons are attracted by the positive voltage applied to the fourth metal layer 29 to thereby impact the inner wall of the aperture 29a. After that, these electrons are attracted by the positive voltage applied to the fifth metal layer 31 to thereby impact the inner wall of the aperture 31a. Finally, these electrons are attracted by the high positive voltage applied to the anode electrode 72 to thereby excite the phosphor layer 71 and provide visible light for viewing.

The pathways of the electrons emitted from the emitters 13 are disturbed by the second metal layer 25, the third metal layer 27, the fourth metal layer 29, and the fifth metal layer 31 while traveling toward the top substrate 70, and thereby the dispersion of these electrons is disturbed to become uniform even though the dispersion of these electrons is not uniform at the beginning. Compared with the conventional spacer for field emission display device, the spacer in this embodiment can be manufactured without need for high aspect ratio, the processing of the spacer is simple, and the structure is stable.

Although the present invention has been explained in relation to its preferred embodiment, it is to be understood that many other possible modifications and variations can be made without departing from the scope of the invention as hereinafter claimed.

What is claimed is:

1. A spacer placed between a top substrate and a bottom substrate for a field emission display device, comprising:
at least two insulating layers for electrical insulation; and
at least one metal layer sandwiched between the insulating layers, wherein the metal layer has plural apertures for electrons passing therethrough and disturbing pathway of electrons as the electrons impact the apertures.

2. The spacer as claimed in claim 1, wherein the metal layer is a sheet metal having plural apertures.

3. The spacer as claimed in claim 1, wherein the metal layer is a mesh grid.

4. The spacer as claimed in claim 1, wherein every two insulating layers sandwich the metal layer.

5. The spacer as claimed in claim 1, wherein every two insulating layers sandwich a plurality of metal layers.

6. The spacer as claimed in claim 1, wherein the inner wall of the aperture is selected from the group consisting of a concave inclined plane, a flat inclined plane, a vertical plane and a protruding inclined plane.

7. The spacer as claimed in claim 1, wherein the inner wall of each aperture is a combination of an upper concave wall and a lower concave wall.

8. The spacer as claimed in claim 7, wherein the diameters of the upper concave wall and the diameter of the lower concave wall are different.

9. The spacer as claimed in claim 1, wherein the diameters of the apertures of the metal layer become larger in the direction toward the top substrate.

10. The spacer as claimed in claim 1, wherein the centers of the apertures on the conductive electrode layer are not on the same line perpendicular to the bottom substrate.

11. The spacer as claimed in claim 1, wherein the insulating layer is composed of plural columns.

12. The spacer as claimed in claim 1, wherein the insulating layer is composed of a continuous structure with plural tubes.
